(19) United States
(12) Patent Application Publication
(10) Pub. No.: US 2015/0042182 A1
(43) Pub. Date: Feb. 12, 2015

(54) Electrical Machines

(71) Applicant: Anthony Richard Glover, Woking (GB)

(72) Inventor: Anthony Richard Glover, Woking (GB)

(73) Assignee: MCLAREN AUTOMOTIVE LIMITED, Woking (GB)

(21) Appl. No.: 14/123,438

(22) PCT Filed: May 31, 2012
(86) PCT No.: PCT/EP2012/060320

§ 371 Date: Feb. 14, 2014

(30) Foreign Application Priority Data
May 31, 2011 (GB) 1109101.4

(51) Int. Cl. H02K 16/00; H02K 3/28; H02K 19/06; H02K 1/24

(52) U.S. Cl. CPC H02K 16/00; H02K 1/246; H02K 3/28; H02K 19/06
USPC 310/46

(57) ABSTRACT

An electrical machine comprising: a first component having a first surface; a second component having a second surface, the first and second components being mounted such that the first surface is constrained to be movable in a cyclical path relative to the second surface; and a coil arranged to induce a magnetic field in one of the surfaces so as to, in at least some configurations of the machine, form a magnetic circuit through that surface; the machine being configured so that: a) the first component and the second component can magnetically interact with each other by virtue of magnetic flux through the first and second surfaces; and b) during at least part of the cyclical path the reluctance of the magnetic circuit is changed by relative motion of the first and second surfaces, that change in reluctance being predominantly due to a component of relative motion of the first and second surfaces in a direction parallel to the shortest distance between the first and second surfaces.

This invention relates to electrical machines. In particular, the present invention relates to electrical machines such as motors and generators. In the case of a motor, mechanical energy may be extracted as a result of an electrical energy input. In the case of a generator, electrical energy may be extracted as a result of a mechanical energy input.

It is highly desirable to improve the effectiveness, and especially the efficiency and power-to-weight ratio of electrical machines. One focus for this is the field of fully electrical vehicles and hybrid electrical vehicles, which are growing in popularity. A hybrid vehicle is a vehicle that utilises at least two distinct power sources for providing drive to the vehicle. One type of hybrid vehicle is a hybrid electric-petroleum vehicle (HEV). An HEV uses an electrical motor and an internal combustion engine as its two power sources. Fully electrical vehicles and HEVs can be more economical than a vehicle that only has an internal combustion engine.

Switched reluctance and permanent magnet motors are favoured in HEVs, respectively for reasons of performance and cost.

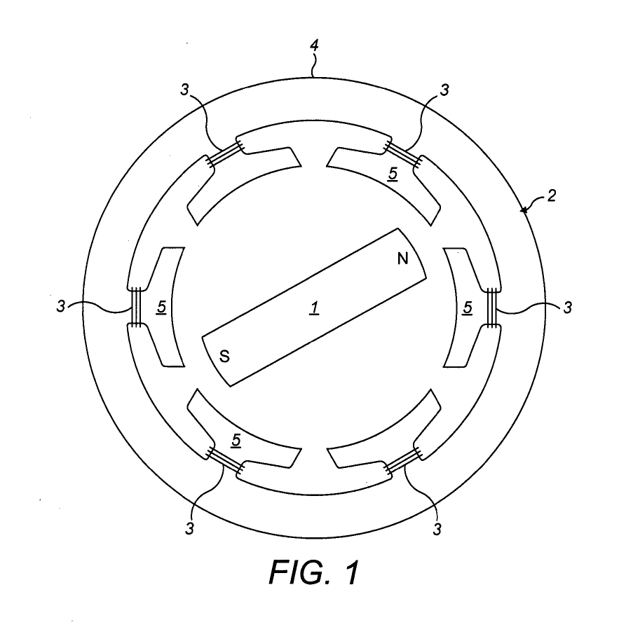

An example of a permanent magnet motor is illustrated in cross-section in FIG. 1. As shown in FIG. 1, the motor has a rotor 1. The rotor is a component of the motor which is mounted so that in operation it can move, most typically rotate, relative to the body of the motor and/or the stator 2 of the motor. The stator is a component of the motor which is mounted so that in operation it is substantially fixed with respect to the body of the motor. As the stator by convention is substantially fixed with respect to the body of the motor, it is known as a static component. The rotor comprises one or more permanent magnets that magnetically polarise parts of the rotor into north and south poles (labelled N and S respectively in FIG. 1). In operation, the rotor rotates about an axis relative to the body of the motor, the axis extending out of the plane of FIG. 1. The rotor magnetically interacts with magnetically polarised regions 5 of the stator. The polarised regions 5 can be polarised using electromagnetic coils 3. In operation, the electromagnetic coils are selectively energised and de-energised in opposite pairs so that they magnetically polarise respective regions 5 of the stator 2. Once magnetic pole pairs have been formed in those regions, the permanent magnets on the rotor magnetically interact with the polarised regions. The rotor will rotate relative to the stator until the north pole of the permanent magnet on the rotor is proximal to a south pole generated in the stator regions 5 and/or until the south pole of the permanent magnet on the rotor is proximal to a north pole generated in the stator regions. Selected electromagnetic coils can subsequently be energised or de-energised to cause the rotor to rotate to a new position. By energising and de-energising selected regions 5 of the stator 2 in sequence, the rotor 1 can be caused to cycle about its axis.

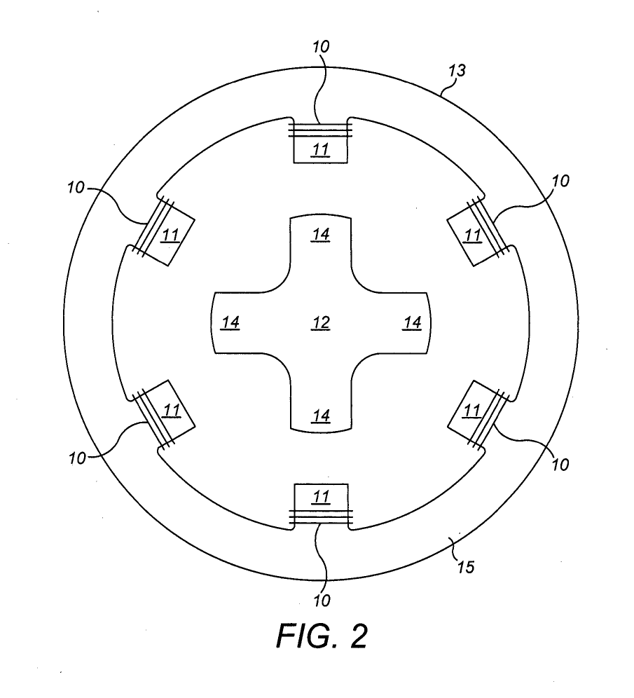

In a switched reluctance motor, instead of using a permanent magnet mounted on the rotor, the rotor is arranged to rotate by means of reluctance torques. This is achieved using a rotor that is made from a ferromagnetic material, such as iron or a composite containing iron. A ferromagnetic material is a material that becomes magnetised in the presence of a magnetic field. Ferromagnetic materials employed in switched reluctance motors and in preferred embodiments of the present invention are those materials exhibiting both a magnetised state (in which the material is magnetically polarised) and an unmagnetised state (in which the material is not magnetically polarised) during operation of the machine. The ferromagnetic material magnetically interacts with magnetically polarised regions on the stator. Those regions on the stator can be selectively energised and de-energised using electromagnetic coils. Energising and de-energising selected regions on the stator in appropriate sequence causes the rotor to rotate about its axis. An example of a switched reluctance motor (using a 6/4 pole structure) is illustrated in FIG. 2. In this motor, electromagnetic coils 10 can be activated to selectively energise respective stator regions 11. This induces pole pairs to form in those stator regions and thereby induces a magnetic circuit, defined by closed loops of magnetic flux, to run through the rotor 12 and the stator 13. The magnetic flux follows a closed loop along a path of least reluctance. Reluctance is a measure of how well a material resists magnetic flux and is defined as:

$$R = \frac{M M F}{φ}$$

where R is the reluctance, MMF is the magnetomotive force and φ is the magnetic flux.

In a switched reluctance motor of the type shown in FIG. 2, the reluctance of the magnetic circuit decreases as a radial arm 14 of the rotor becomes proximal to an energised region of the stator. When an arm of the rotor is fully aligned with an energised region of the stator, the reluctance of the magnetic circuit is at a minimum. By energising and de-energising selected regions 11 of the stator 13 in sequence, the rotor 12 can be caused to cycle about its axis.

Conventional permanent magnet motors and switched reluctance motors both have advantages and disadvantages. For example, conventional permanent magnet and switched reluctance motors typically use a large volume of stator core or back iron, as indicated at 4 and 15, in order to complete the magnetic circuit. This increases the mass of the motor. Conventional switched reluctance motors are typically less power dense than permanent magnet motors but can be cheaper to manufacture.

Electrical generators can be formed in an analogous way to the motors described above, and similar considerations apply to their design.

There is a need for electrical motors and generators that at least partly address the above problems.

According to the present invention there is provided electrical machines as set out in the accompanying claims. Each set of claims is independent of the others.

The present invention will now be described by way of example, with reference to the accompanying drawings. In the drawings:

FIG. 1 shows a permanent magnet motor.

FIG. 2 shows a switched reluctance motor.

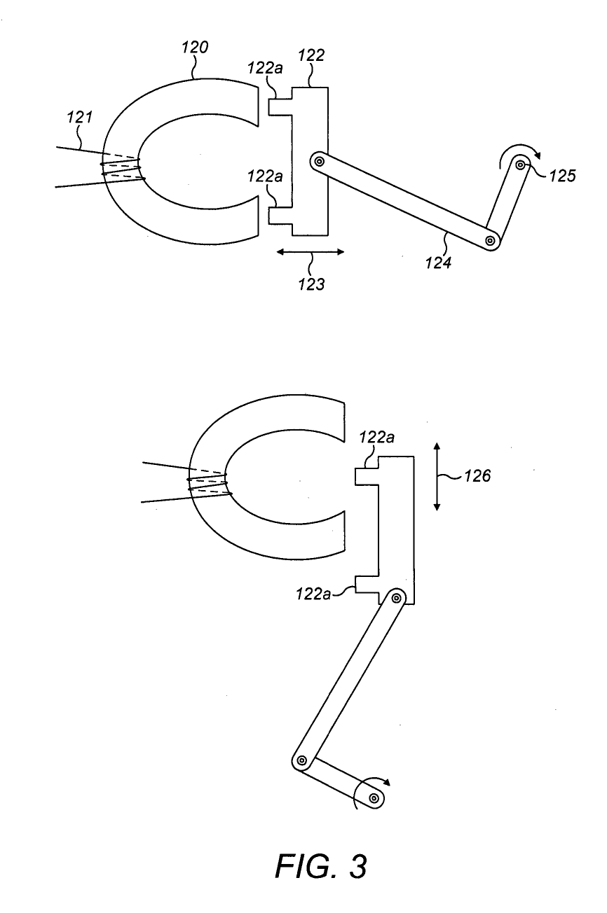

FIG. 3 shows two motors to illustrate their operating principles.

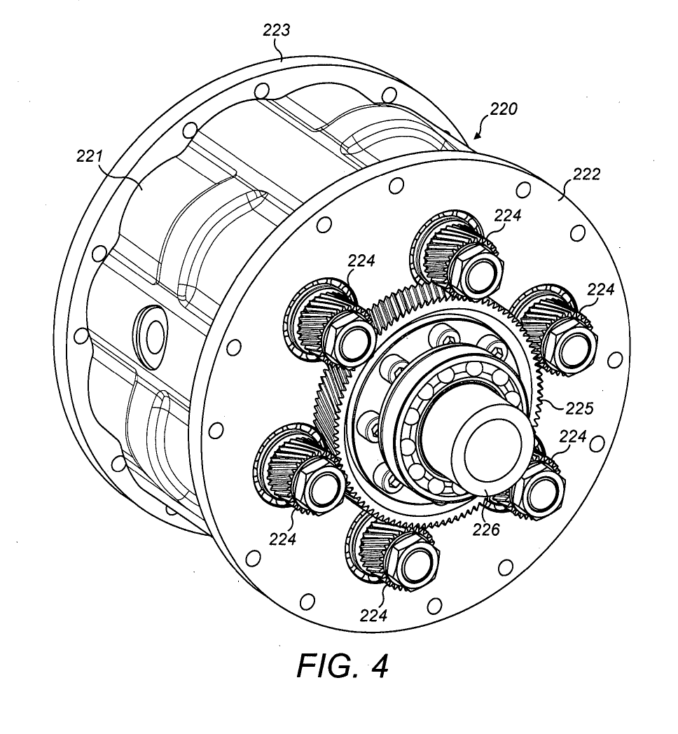

FIG. 4 is an isometric view of a first design of multiple-rotor motor.

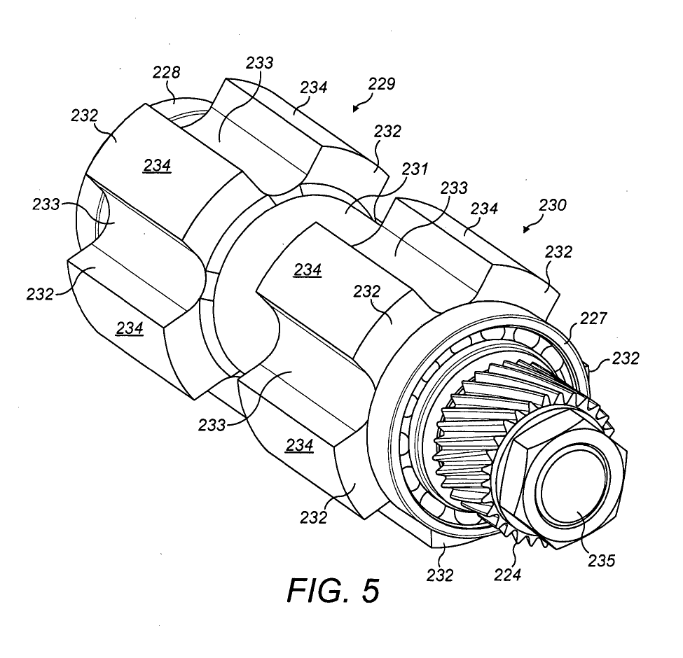

FIG. 5 is an isometric view of a rotor of the motor of FIG. 4.

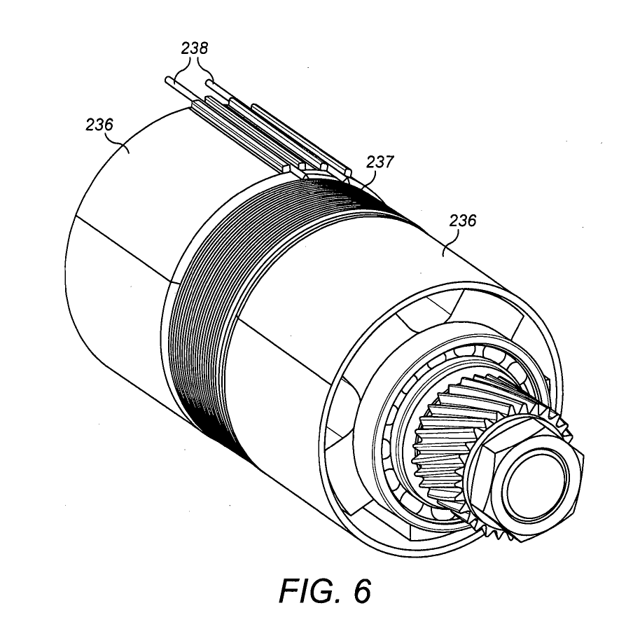

FIG. 6 is an isometric view of a rotor of the motor of FIG. 4 with a coil.

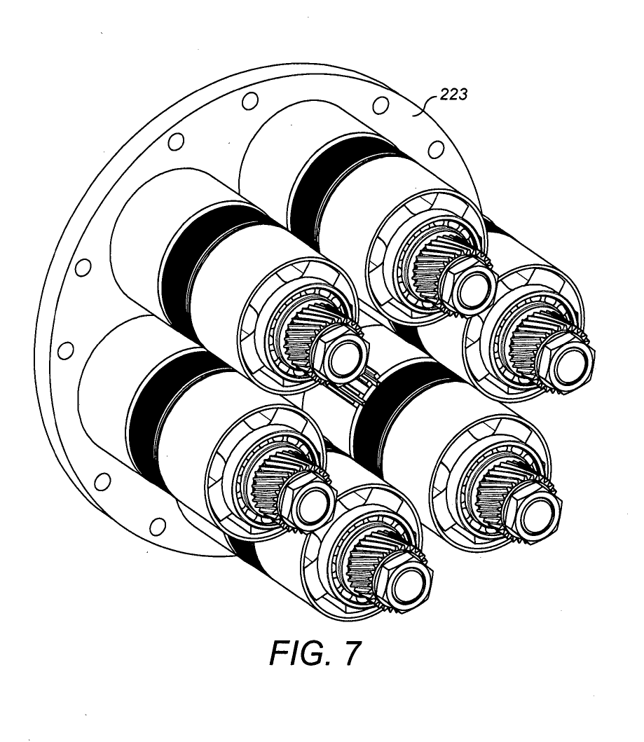

FIG. 7 is an isometric view of rotors of the motor of FIG. 4 in place on a rear plate.

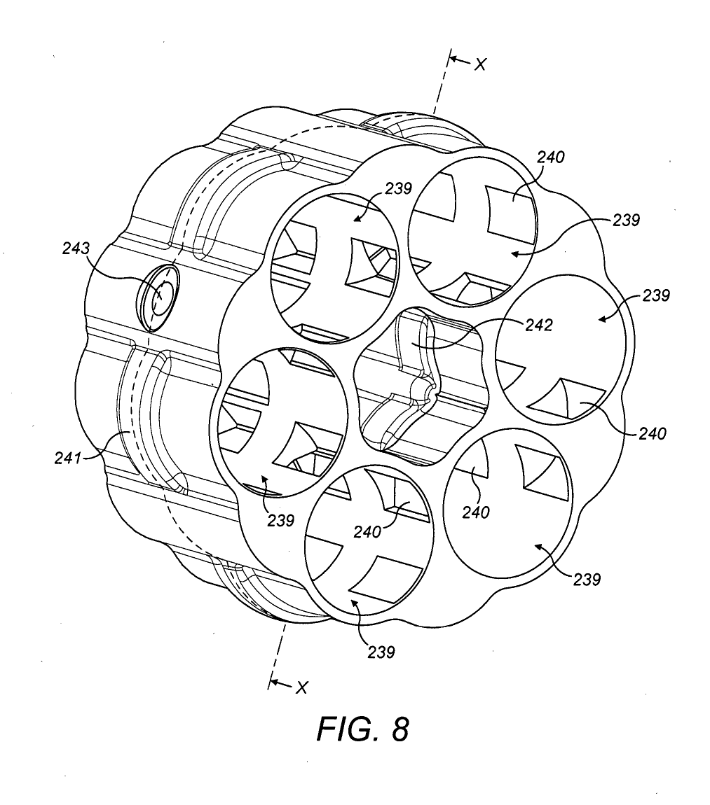

FIG. 8 is an isometric view of a stator housing of the motor of FIG. 4.

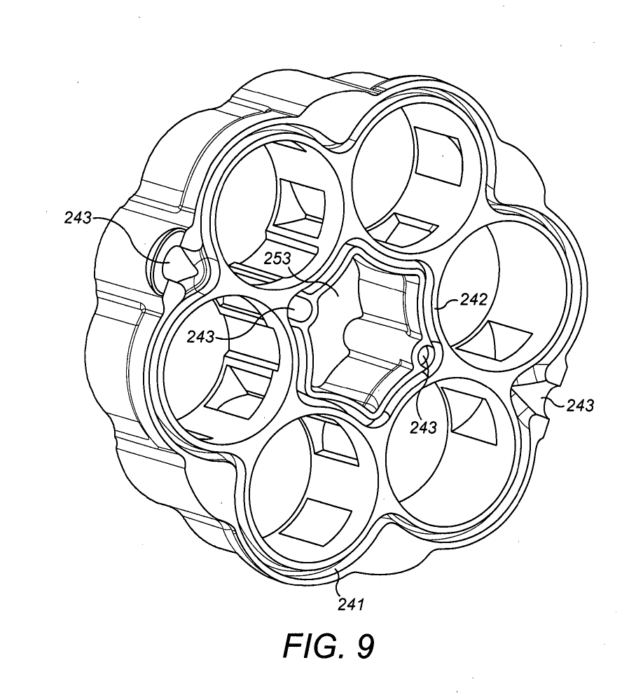

FIG. 9 is an isometric section of the stator housing of FIG. 8.

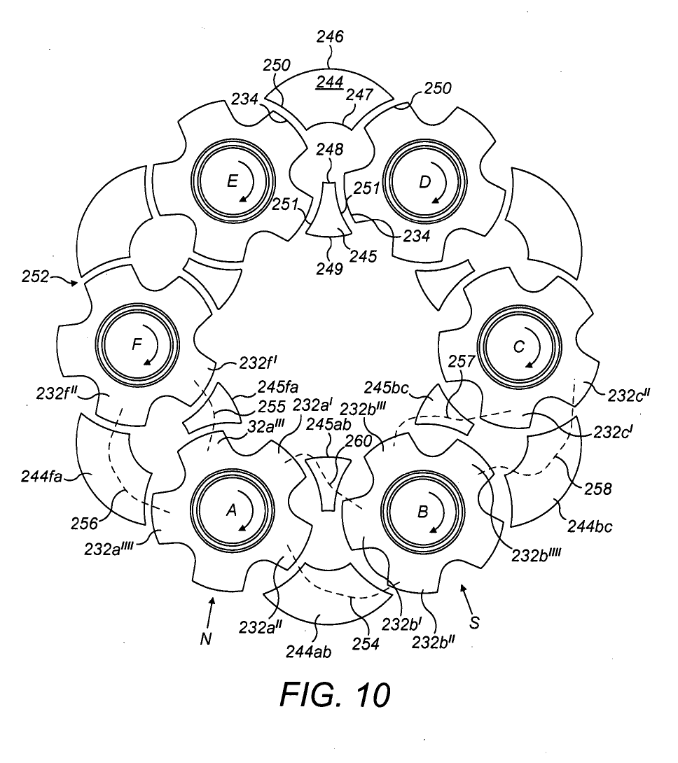

FIG. 10 is partial cross-section of the motor of FIG. 4 in a first configuration.

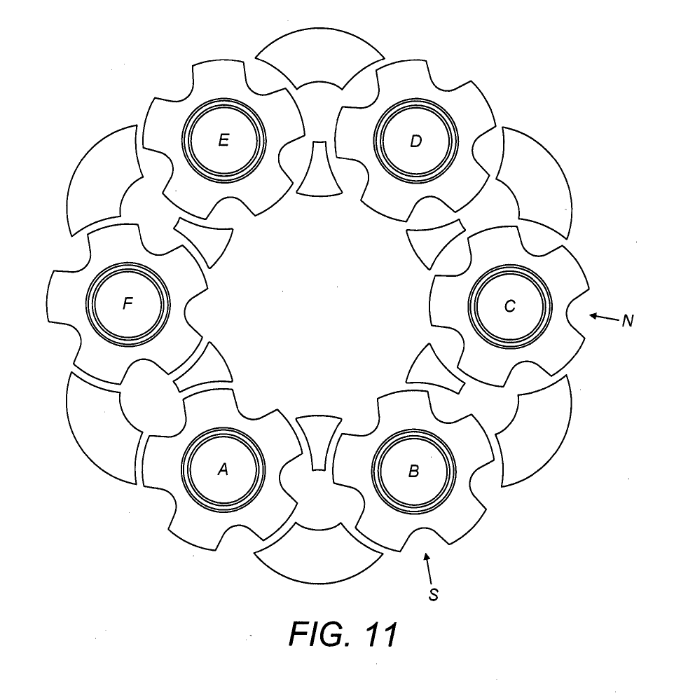

FIG. 11 is partial cross-section of the motor of FIG. 4 in a second configuration.

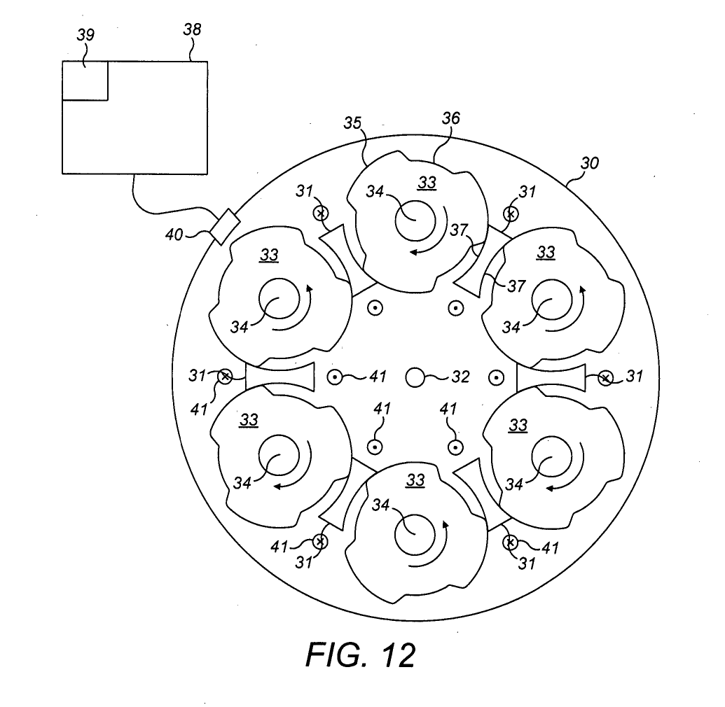

FIG. 12 is a cross-section of a second multiple-rotor motor.

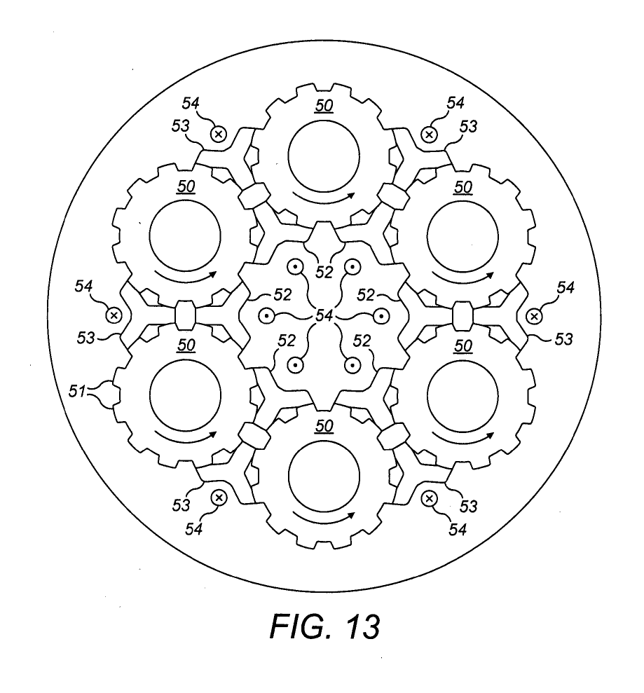

FIG. 13 is a cross-section of a third multiple-rotor motor.

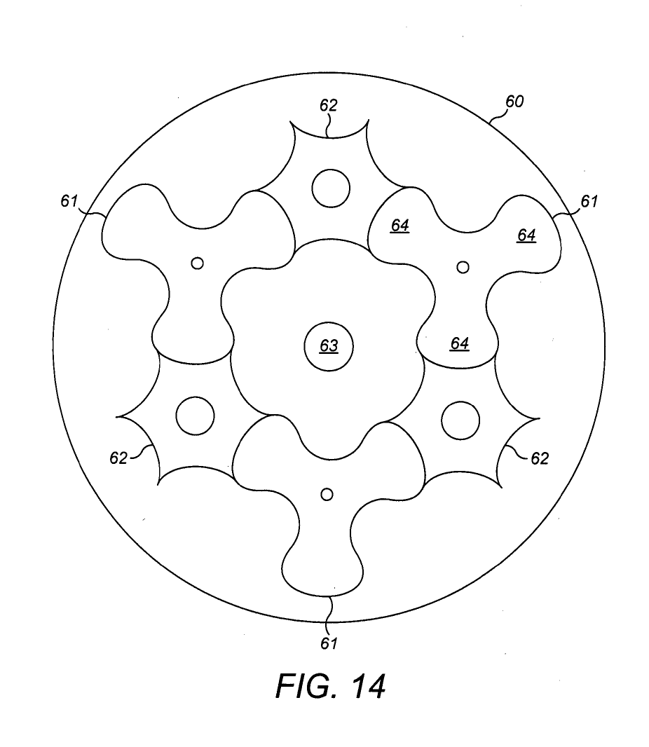

FIG. 14 is a cross-section of a fourth multiple-rotor motor in a first configuration.

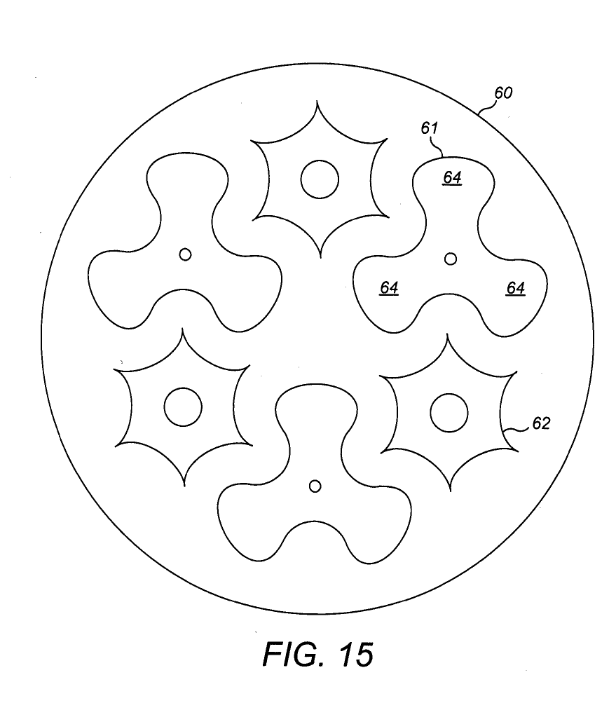

FIG. 15 is a cross-section of the multiple-rotor motor of FIG. 14 in a second configuration.

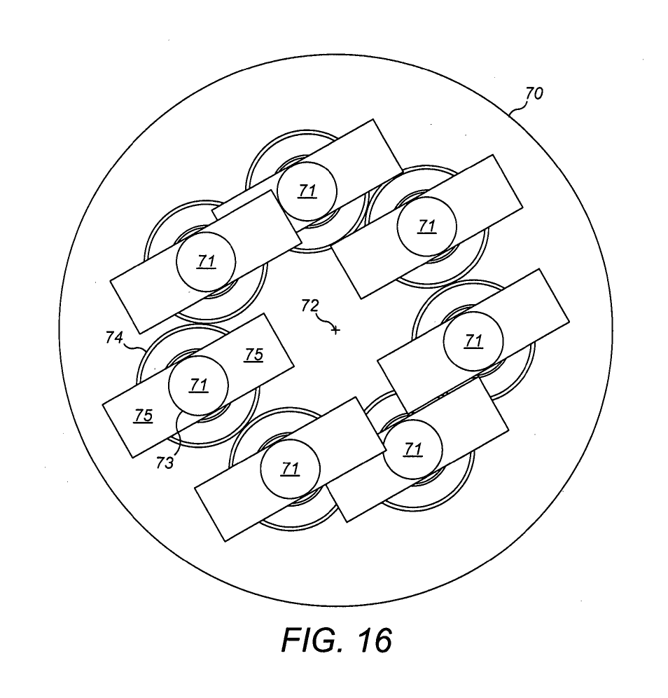

FIG. 16 is a cross-section of a fifth multiple-rotor motor in a first configuration.

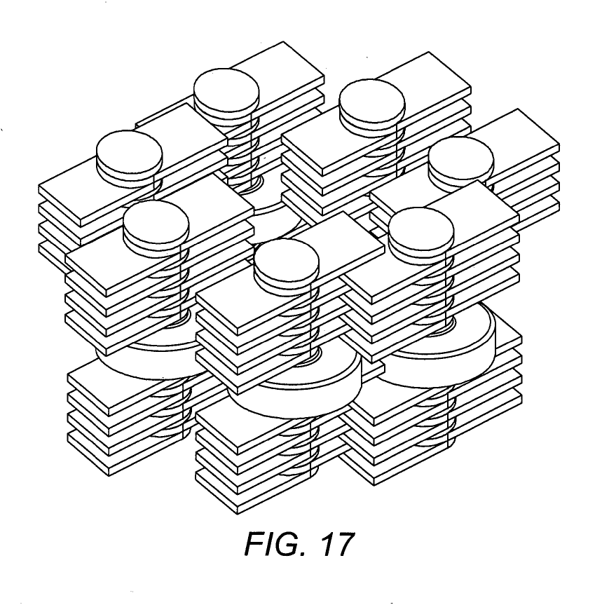

FIG. 17 is an isometric view of the multiple-rotor motor of FIG. 16.

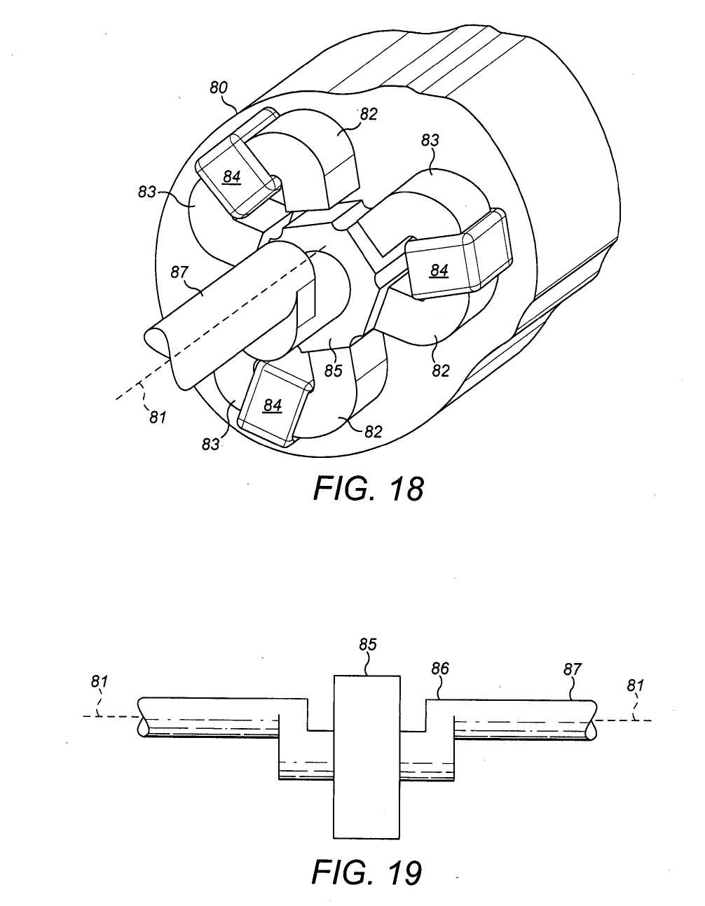

FIG. 18 is an isometric view of a motor.

FIG. 19 is a partial cut-away view of the motor of FIG. 18.

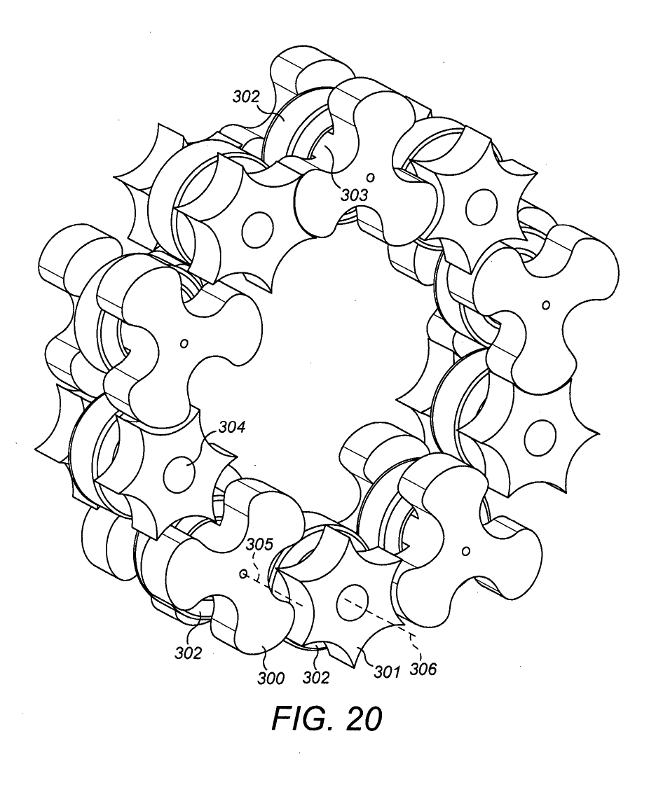

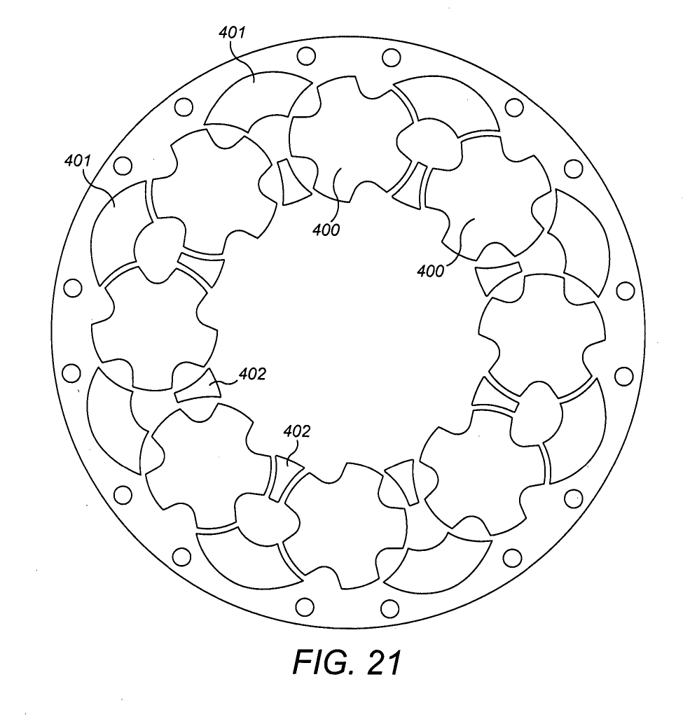

FIG. 20 is an isometric view of a sixth multiple-rotor motor.

FIG. 21 is a cross-section of the motor of FIG. 20.

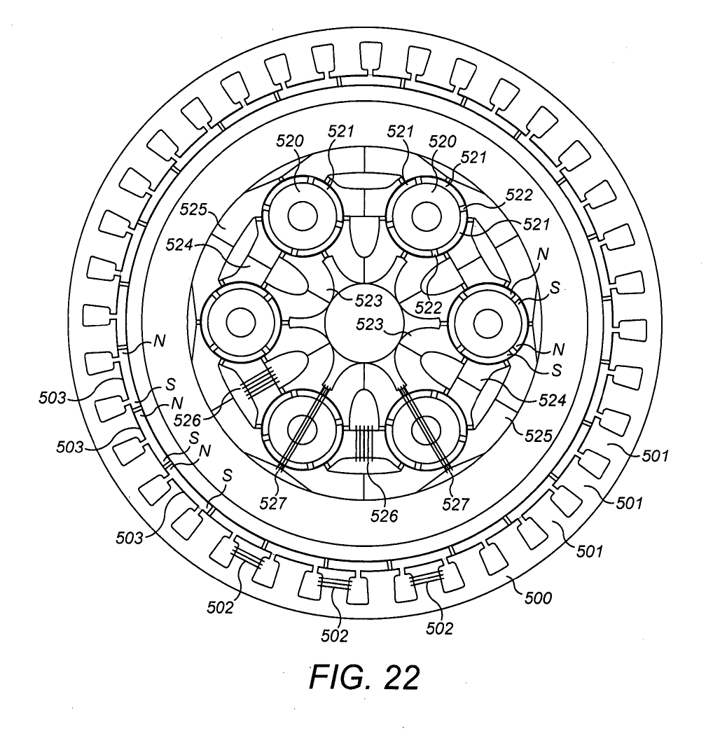

FIG. 22 is a cross-section of two motors.

Electrical machines are electro-motive energy converters. In other words, electrical machines convert electrical energy into kinetic energy and/or convert kinetic energy into electrical energy. The term electrical machine is meant to include both electrical generators and electrical motors. The term electrical machine does not encompass magnetic transmission systems, although magnetic transmission systems may receive part of their drive from electrical machines. For ease of description the following embodiments will be described with specific reference to motors. However, the configurations described herein are also suitable for use as electrical generators.

In conventional motors, such as those described in the introduction above, the change in reluctance over a cycle is primarily due to changes in the overlap between proximal teeth of neighbouring magnetic components. This is partly because reluctance is a function of magnetic flux, which is determined by:

φ=∫∫B·dS

where φ represents the magnetic flux, B represents the magnetic field and lids is the surface integral. The thickness of a component through which the flux is to flow is uniform to avoid local saturation. As a result, taking the magnetic field and the thickness to be constant, the magnetic flux in the magnetic circuit, and hence the reluctance in the circuit, changes as the amount of overlap changes.

FIG. 3 shows two illustrative designs of electrical motor.

In a first motor, an electromagnet 120 can be energised by a coil 121 to attract an armature 122 through respective interacting surfaces. Interacting surfaces are those surfaces through which components magnetically interact with each other. As such, a surface may be an interacting surface for only part of a motor's operation, depending on the configuration of the motor, for example, in dependence on the energisation sequence of the electromagnetic coils of the motor. The armature is constrained to move linearly as indicated at 123 in a direction such that, as the armature moves linearly along the path indicated at 123, the gap between the closest-spaced parts of the magnet 120 and the armature 122 changes. However the overlap between the interacting surfaces of the magnet and the closest parts 122a of the armature remains the same as the armature moves linearly along the path indicated at 123. The armature is attached to a crank mechanism 124 which converts the linear motion of the armature into rotation of a shaft 125. A spring or flywheel can be used to restore the armature to a position distant from the magnet so that the machine can rotate the shaft continuously by intermittent actuation of the electromagnet.

The second motor of FIG. 3 is similar to the first, except that the armature is constrained to move linearly as indicated at 126 in a direction such that as the armature moves linearly along the path indicated at 126, the gap between the closest-spaced parts of the magnet and the closest parts 122a of the armature stays the same but the overlap between the two components changes.

In a conventional motor, such as is shown in FIGS. 1 and 2, the principal source of motive power results from a change in overlap between magnetically interacting components, as illustrated by the second motor of FIG. 3. In contrast, in preferred embodiments of the invention taught herein, the principal source of motive power results from a change in the shortest distance between interacting surfaces on magnetically interacting components, as illustrated by the first motor of FIG. 3, as the relctance of the magnetic circuit changes. The size of the gap between interacting surfaces on magnetically interacting components may be varied in several different ways. For example, the gap may be varied by means of the topology of the interacting surfaces. In this case, the size of the gap varies across the interacting surfaces when the interacting surfaces are proximal. Alternatively or in addition, the gap may be varied by means of the mounting of the magnetically interacting components. This is the scenario depicted in the first motor of FIG. 3.

Arranging a motor to have a varying shortest distance between interacting surfaces of magnetically interacting components enables that motor to output a larger torque than a comparable conventional motor. This is because the size of the gap between the closest points on two magnetic components that are effective for the passage of magnetic flux affects the reluctance of the circuit. More specifically, a larger gap results in a larger reluctance of the circuit. Therefore, an increasing magnetic field can be generated by increasing the current flowing in the coil of the motor as the gap increases. This results in such a motor capable of outputting a larger torque than a comparable conventional motor.

The electrical machines to be described below employ a number of features, amongst them:
the use of a variable air gap between neighbouring elements of a flux path, as in the first motor of FIG. 3;
the use of multiple rotors which together form part of a common flux path, the flux that passes through those rotors inducing them to rotate together when the machine is acting as a motor;
one or more rotors that can be energised by a respective coil that does not rotate with the rotor;
multiple selectively energisable magnets arranged around an armature and which can be energised selectively so as to cause the armature to cycle around a generally circular path.

In one aspect of the present application, there is disclosed an electrical machine from which energy may be extracted comprising at least two rotors. Each rotor is arranged to revolve about a respective axis and to magnetically interact with at least one other rotor in order to permit energy to be extracted from the machine. The energy extracted is either electrical or motive energy as the primary function of the electrical machine is to convert electrical energy into motive energy and vice versa. The rotor interaction directly causes electro-motive energy conversion in the electrical machine.

According to another aspect of the present application, there is provided an electric machine having a rotor arranged to revolve around its own respective axis and a static electromagnetic coil arranged to encircle the axis of that rotor so as to magnetically polarise that rotor.

The electrical machine may comprise at least two rotors, such as is defined in claim 2 of claim set 2. In this case, the electric machine comprises at least two rotors, each rotor being arranged to revolve about its own respective axis and at least two electromagnetic coils, each electromagnetic coil being associated with a rotor and being arranged to encircle the axis of that rotor so as to magnetically polarise that rotor.

The following features can be applied to each of the above mentioned aspects of the invention. Advantageous effects of these features may be discussed in relation to exemplary embodiments illustrated in the figures.

The respective rotation axes of each rotor are parallel to each other and separated from other rotor rotation axes by a non-zero displacement. In other words, the respective rotation axes are not coincident.

Preferably, the rotors are equally spaced about a central axis. Each rotor may terminate in a gear and be arranged to drive, or be driven by a sun gear. The sun gear may be preferably configured to rotate about the central axis. The sun gear may be arranged to provide and/or receive a drive from an output shaft of the electrical machine.

The rotors may be mechanically linked such that in use they rotate in the same direction. In the alternative, the rotors may be mechanically linked such that in use immediately adjacent rotors rotate in opposite directions.

The rotors may be arranged to have an angular offset from at least one neighbouring rotor. This angular offset could be selected such that the electrical machine can induce rotation of a least one of the rotors in any configuration without the use of an additional machine. The amount of angular offset may be quantified by determining the angular difference between corresponding poles of neighbouring rotors. The poles are only present on a rotor when the rotor is magnetically polarised. If the rotors comprise protrusions, such as teeth, the angular offset may be quantified by measuring the angular difference between corresponding protrusions in a similar manner. In an exemplary embodiment, the rotors are arranged such that when some of the poles (or protusions) of one rotor are exactly aligned with poles (or protrusions) of one neighbour, some other of the rotor poles (or protrusions) are exactly misaligned with poles (or protrusions) of another neighbour.

Neighbouring rotors may be arranged to interact with each other directly. In other words, neighbouring rotors may interact with each other without the intermediary of a stator. In this case, at least every other neighbouring rotor is arranged to have its rotation axis encircled by a static electromagnetic coil for magnetically polarising that rotor. More preferably, each rotor in the system is arranged to have such a static electromagnetic coil for magnetically polarising each rotor. In the alternative, neighbouring rotors may be arranged to interact with each other indirectly. In other words, neighbouring rotors may interact with each other through an intermediary stator component positioned between neighbouring rotors. The stator component comprises a small mass relative to the system as a whole. The stator component may be arranged to be magnetically polarised by a static electromagnetic coil.

Preferably, the electric machine does not comprise any stator backiron for completing the magnetic circuit created during magnetic interactions.

Exemplary embodiments of these principles of the present application are discussed below with reference to the figures.

FIGS. 4 to 11 show a first embodiment of a motor having multiple rotors.

As illustrated in FIG. 4, the motor comprises a casing 220 having a generally annular side-wall 221, a front end wall 222 and a rear end wall 223. Six rotor units are mounted inside the casing such that they protrude through the front end wall and terminate in gears 224. All the gears 224 intermesh with a sun wheel 225. The sun wheel 225 is mounted such that it can rotate relative to the casing. The rotor units are mounted so that they are equally spaced about the rotation axis of the sun wheel and are arranged to rotate about mutually parallel axes relative to the casing. The mutually parallel axes are not coincident. In other words, each rotor is arranged to rotate about its own respective axis, each axis being separated from another axis by a non-zero displacement. The cooperation of the gears 224 with the sun wheel means that the rotors are constrained to rotate together in the same direction and at the same rate. A drive shaft 226 is attached to the sun wheel. Mechanical drive can be taken from that shaft when the motor is operating as a motor. Mechanical drive can be provided to that shaft during operation as a generator.

An individual rotor unit is shown in FIG. 5. Bearings 227 and 228 are provided for mounting the rotor unit to the front and rear end walls respectively. The central part of the rotor unit comprises two identical active blocks 229, 230 connected by a neck 231. Each active block is cylindrical and of generally stellate cross-section transverse to the axis of the rotor. Each active block comprises five ribs or salients 232 which protrude radially and are evenly spaced in the circumferential direction around the rotor. Adjacent ribs of an active block are spaced from each other by a groove 233. Each rib has a radially external surface 234 all of which lie on a common circular cylinder about the axis of the rotor. In the axial direction each external surface occupies the entire length of the block of which it is part. In the circumferential direction the width of each external surface is such as to be equal to the circumferential spacing between adjacent ribs on an active block. Since there are five ribs on each active block, the circumferential width of each external surface is one tenth of the circumference of the cylinder on which it lies. The radius of the rotor unit at the neck 231 and in the grooves 233 is less than at the ribs 232, so the ribs stand proud of the rest of the central part of the rotor unit.

The active blocks 229, 230 are rigidly connected together by the neck 231 and are rigidly connected to the gear 224 by a shaft 235. The blocks 229, 230 and the neck 231 are formed of ferromagnetic material. The blocks could be formed integrally with each other and the neck, for example by sintering of a soft magnetic composite material. The blocks could be formed separately, for example by sintering or machining, and then threaded onto a splined rod which then constitutes the neck 231 and the shaft 235.

Each rotor unit is equipped with a respective coil of electrically conductive material. The relationship between the rotor unit and its coil is shown in FIG. 6. A thin jacket 236 of a non-magnetic material, for instance a polymer material, is wrapped around the rotor unit. The jacket is shaped so that the rotor unit can rotate freely within it. The jacket is further shaped to define an annular channel open to the exterior around the neck 231 of the rotor. A coil 237 of electrically conductive (e.g. copper) wire winds around the rotor in the channel. The ends 238 of the wire extend axially along the jacket so that connection can be made to them as will be described below. In this way the coil can be used to magnetically polarise the rotor unit whilst the rotor unit rotates relative to the coil within the jacket. The coil directly magnetically polarises the rotor unit as it magnetically polarises the rotor without first polarising another component. When the rotor unit is polarised by means of the coil, the blocks 229, 230 will be of opposite magnetic polarity. The coil could be wound around the rotor once the jacket is in place on the rotor. In an alternative arrangement, the coil could be pre-wound and then threaded onto a shaft to which at least one of the blocks 229, 230 is subsequently attached. In either arrangement, the eventual structure is such that the rotor is spaced from the coil by non-magnetic material and is free to rotate relative to the coil, but the coil encircles the rotor between the blocks 229, 230 and can therefore be activated to magnetically polarise the blocks relative to each other whilst the rotor rotates within it. The fact that the coil does not need to rotate with the rotor makes it easier to make electrical connections to the coil, since no brushes or slip rings are needed. This reduces mass, simplifies manufacturing and improves reliability.

FIG. 7 shows the rotor units, together with their jackets and coils, attached to the rear end wall 223. The remainder of the motor is removed for clarity.

FIGS. 8 and 9 show a stator enclosure. FIG. 9 is a cross-sectional view of the stator enclosure of FIG. 8 on the plane X-X of FIG. 8. The stator enclosure is intended to slip over the rotors when they are in place on the rear end wall.

The stator enclosure has six channels, indicated generally at 239, which run through the stator enclosure in the axial direction and are sized to receive the rotor units and their associated jackets and coils in such a way that the rotor units can rotate freely within the stator enclosure. The stator unit also has pockets 240, only some of which are annotated in FIG. 6. The pockets are intended to snugly receive stator elements and to hold the stator elements in place. The configuration of the stator elements will be described below. The stator enclosure defines cooling channels 241, 242, seen in cross-section in FIG. 9. Cooling channel 241 runs outside the zone where the coils will be located when the stator enclosure is in place. Cooling channel 242 runs inside the zone where the coils will be located when the stator enclosure is in place. A cooling fluid such as water can be circulated in the channels when the motor is in use in order to keep the coils from overheating. Inlets and outlets 243 for the cooling fluid are provided. In this design of motor, the coils are readily accessible around a substantial proportion of their circumference: as can be seen in FIG. 9, the cooling channels adjoin the coils over more than half of the coils' lengths. Since the coils are the source of a considerable proportion of the heat generated in the motor, this means that the motor can be cooled particularly effectively.

In the axial direction the pockets 240 are located so that the stator elements will lie in the same plane as the active blocks 229, 230 of the rotor units when the motor is assembled. The depth of the stator elements in the axial direction can conveniently be the same as the depth of the active blocks.

FIG. 10 illustrates the stator elements and their relationship to the active blocks. In FIGS. 10 and 11 individual ribs 232 and stator elements 244, 245 are identified by suffixes of letters and dashes.

The stator elements comprise a set of outer stator elements 244 and a set of inner stator elements 245. Each stator element is of constant cross-section in the motor's axial direction. Each stator element is of the form of a segment of an arc, having two side surfaces 246, 247, 248, 249 and two end surfaces, 250, 251. Each stator element is located between a respective pair of adjacent rotors, and the end surfaces 250, 251 are positioned to adjoin the neighbouring rotors. Each end surface lies on a circular cylinder about the axis of the rotor that it neighbours, and is located relative to the rotor so as to be close to but outside the path described by the outer surfaces 234 of the ribs 232. The gap between the surfaces 250, 251 and the outer surfaces of the ribs is filled with air or another non-magnetic fluid. The interior of the motor could be evacuated, leaving air at a very low pressure. The width of the end surfaces 250, 251 is roughly equal to the width of the outer surfaces 234 of the ribs. The pair of inner and outer stator elements between each adjoining pair of rotors are located so that the end surfaces 250, 251 are spaced from each other by essentially the same distance as adjoining ribs on the rotors, so that the end surfaces of both those stator elements can confront respective ribs of a rotor simultaneously, as shown at 252. Each stator element is of generally constant cross-section as it extends in an arc from one of its end surfaces to the other.

The stator elements are formed of a ferromagnetic material.

A control unit is connected to the leads extending from the coils. The control unit receives input from a position sensor which senses the rotational state of the rotors. Conveniently, the control unit and the position sensor can be located in the void 253 in the centre of the stator enclosure and the position sensor can sense the position of the sun wheel 225. The control unit energises the coils independently in turn in order to cause the motor to operate on switched reluctance principles. The time and the sense in which the coils are energised is determined by the control unit in accordance with a pre-defined programme and in dependence on the sensed position of the motor in its cycle.

The mechanism of energisation will be described with reference to FIGS. 10 and 11, taking the rotors to be rotating clockwise. The active blocks of the six rotor units are labelled A to F. When the coil of a rotor unit is energised the active blocks of that rotor unit are oppositely polarised. For clarity, only the polarity of the blocks shown in the plane of FIGS. 10 and 11 will be described below. The other set of blocks operate in the same mechanical sense but the opposite magnetic sense.

When the motor is in the state shown in FIG. 10, the coil of the rotor unit of which block A is part is energised to polarise block A north (N), and the coil of the rotor unit of which block B is part is energised to polarise block B south (S). The desired polarisations are achieved by causing electrical current to flow in the appropriate directions in the respective coils. This causes the following interactions:

1. The north-polarised rib 232a′ of block A is magnetically attracted to the south-polarised rib 232b′ of block B through inner stator element 245ab, as illustrated by flux path 260. The north-polarised rib 232a″ of block A is magnetically attracted to the south-polarised rib 232b″ of block B through outer stator element 244ab, as illustrated by flux path 254. This interaction encourages the rotor units of A and B to rotate clockwise relative to the motor housing towards a state in which ribs 232a′ and 232b′ would be in full overlap with the end surfaces of stator element 245ab, and ribs 232a″ and 232b″ would be in full overlap with the end surfaces of stator element 244ab.

2. Although block F is not polarised by its coil, stator elements 244fa and 245fa provide routes for block A to magnetically attract block F. Rib 232a′″ of block A attracts rib 232f of block F through inner stator element 245fa, as illustrated by flux path 255. Rib 232a″ of block A attracts rib 232f″ of block F through outer stator element 244fa, as illustrated by flux path 256. This interaction encourages the rotor units of A and F to rotate clockwise relative to the motor housing towards a state in which ribs 232a′″ and 232f would be in full overlap with the end surfaces of stator element 245fa, and ribs 232a″ and 232r would be in full overlap with the end surfaces of stator element 245fa.

3. Although block C is not polarised by its coil, stator elements 244bc and 245bc provide a route for bock A to magnetically attract block C. In the state exactly as illustrated in FIG. 8 this attraction will not encourage rotation of the rotor of C because the relevant ribs of block C are evenly spaced on either side of stator elements 244bc and 245bc. However, stator elements 244bc and 245bc provide routes for block B to magnetically attract block C once further motion of the rotors has taken place due to interactions 1 and 2 as described above. Then, rib 232b′″ of block B attracts rib 232c′ of block C through inner stator element 245bc, as illustrated by flux path 257; and rib 232b′″ of block B attracts rib 232e of block C through outer stator element 244bc, as illustrated by flux path 258. This interaction encourages the rotor units of B and C to rotate clockwise relative to the motor housing towards a state in which ribs 232b′″ and 232c′ would be in full overlap with the end surfaces of stator element 245bc, and ribs 232a″ and 232c″ would be in full overlap with the end surfaces of stator element 245bc.

These three interactions together cause the rotor units to rotate clockwise until they reach the state shown in FIG. 11. It will be seen that in this state rotors A, B, C and D are in the same mutual relationship as rotors F, A, B and C were in when the motor was in the state illustrated in FIG. 10. When the rotors reach the state shown in FIG. 11, the control unit performs the following actions:

a. it de-energises the coil of the rotor unit of which block A is part;

b, it leaves the coil of the rotor unit of which block B is part energised to polarise block B south; and

c. it energises the coil of the rotor unit of which block C is part to polarise block C north.

This causes rotors A, B, C and D to interact in the same way as rotors F, A, B and C interacted in the state of FIG. 10, encouraging continued rotation of the rotor units. Each time the rotor units rotate a further 12° and so come to a state analogous to that of FIGS. 10 and 11 the control unit switches so that the next pairing of coils is appropriately energised. In this way, the motor rotates continuously.

Opposite ends of each rotor are magnetically polarised relative to each other. The stator elements are located in the plane of only a single end of the rotors: they do not extend into the plane of the coils. Therefore, the magnetic flux paths are completed via both ends of the rotors: the flux paths extend from one end of one rotor through a first stator element to the corresponding end of a second rotor, through the central part of that second rotor to the other end of that rotor, through another stator element to the other end of the first rotor and back through the central part of the first rotor to the first end of the first rotor.

Motors can be constructed on similar principles with differing numbers of rotors. Some of these variants can make use of repulsion between neighbouring rotors as well as attraction. The following tables give some examples of how these motors can be commutated. Each pair of side-by-side tables relates to a particular design of motor, as identified. In each pair of side-by-side tables the left-hand table indicates an estimate of the forces between pairs of neighbouring rotors, and the right-hand table indicates the applied polarisation of one plane of active blocks of the rotors. In each table the top row indicates the rotor or pairing of rotors to which the respective column relates. Each other row corresponds to one phase in the operation of the motor, with the motor returning to the initial state after a full cycle once all rows have been implemented. In the left-hand table, the sign of the number is positive for attraction and negative for repulsion and the magnitude of the number indicates roughly the magnitude of the force.

8 Rotor, 8 Phase

| 1 | 2 | 3 | 4 | 5 | 6 | 7 | 8 |
|---|---|---|---|---|---|---|---|
| 2 | 3 | 4 | 5 | 6 | 7 | 8 | 1 |
| 1 | 1 | 1 | 1 | −1 | −1 | −1 | −1 |
| −1 | 1 | 1 | 1 | 1 | −1 | −1 | −1 |
| −1 | −1 | 1 | 1 | 1 | 1 | −1 | −1 |
| −1 | −1 | −1 | 1 | 1 | 1 | 1 | −1 |
| −1 | −1 | −1 | −1 | 1 | 1 | 1 | 1 |
| 1 | −1 | −1 | −1 | −1 | 1 | 1 | 1 |
| 1 | 1 | −1 | −1 | −1 | −1 | 1 | 1 |
| 1 | 1 | 1 | −1 | −1 | −1 | −1 | 1 |
| 1 | 2 | 3 | 4 | 5 | 6 | 7 | 8 |
| N | S | N | S | N | N | N | N |
| N | N | S | N | S | N | N | N |
| N | N | N | S | N | S | N | N |
| N | N | N | N | S | N | S | N |
| N | N | N | N | N | S | N | S |
| S | N | N | N | N | N | S | N |
| N | S | N | N | N | N | N | S |
| S | N | S | N | N | N | N | N |

4 Rotor, 4 Phase

| 1 | 2 | 3 | 4 |
|---|---|---|---|
| 2 | 3 | 4 | 1 |
| 1 | 1 | −1 | −1 |
| −1 | 1 | 1 | −1 |
| −1 | −1 | 1 | 1 |
| 1 | −1 | −1 | 1 |
| 1 | 2 | 3 | 4 |
| N | S | N | N |
| N | N | S | N |
| N | N | N | S |
| S | N | N | N |

8 Rotor, 4 Phase

| 1 | 2 | 3 | 4 | 5 | 6 | 7 | 8 |
|---|---|---|---|---|---|---|---|
| 2 | 3 | 4 | 5 | 6 | 7 | 8 | 1 |
| 1 | 1 | −1 | −1 | 1 | 1 | −1 | −1 |
| −1 | 1 | 1 | −1 | −1 | 1 | 1 | −1 |
| −1 | −1 | 1 | 1 | −1 | −1 | 1 | 1 |
| 1 | −1 | −1 | 1 | 1 | −1 | −1 | 1 |
| 1 | 2 | 3 | 4 | 5 | 6 | 7 | 8 |
| N | S | N | N | N | S | N | N |
| N | N | S | N | N | N | S | N |
| N | N | N | S | N | N | N | S |
| S | N | N | N | S | N | N | N |

6 Rotor, 6 Phase

| 1 | 2 | 3 | 4 | 5 | 6 |
|---|---|---|---|---|---|
| 2 | 3 | 4 | 5 | 6 | 1 |
| 2 | 1 | 0 | 0 | 0 | 1 |
| 1 | 2 | 1 | 0 | 0 | 0 |
| 0 | 1 | 2 | 1 | 0 | 0 |
| 0 | 0 | 1 | 2 | 1 | 0 |
| 0 | 0 | 0 | 1 | 2 | 1 |
| 1 | 0 | 0 | 0 | 1 | 2 |
| 1 | 2 | 3 | 4 | 5 | 6 |
| N | S | | | | |
| | S | N | | | |
| | | N | S | | |
| | | | S | N | |
| | | | | N | S |
| N | | | | | S |

In these examples, the rotors have projecting ribs or salients arranged as follows:
in the 8 rotor, 8 phase motor, each rotor is a quarter tooth or 9° shifted relative to the neighbouring rotors;
in the 4 rotor, 4 phase motor and the 8 rotor, 4 phase motor, each rotor is a half tooth or 18° shifted relative to the neighbouring rotors;
in the 6 rotor, 6 phase motor, each rotor is 12° shifted relative to the neighbouring rotors.

Control arrangements that have lower numbers of phases may be preferred since they require less frequent switching of the coils.

Other numbers of ribs than five could be provided on each rotor. The control arrangements would be altered accordingly.

The motor of FIGS. 4 to 11 has a number of potential advantages. First, the mass of the stator material it requires is relatively small, meaning that the motor can be relatively powerful for little mass, compared to conventional motor topologies. Second, the configuration of the coils means that they can be easily cooled since they are readily accessible from both inside and outside the ring of rotors. Third, the motor can be assembled relatively easily; in particular, the coils can readily be formed on the rotors or slipped over a rod to which the rotor blocks are attached. Fourth, as shown by the positive and negative interaction values in the tables above, embodiments of this type of motor can use attractive and repulsive forces and/or interactions between numerous ones of the rotors simultaneously, which allows a relatively high power to be achieved. Fifth, each magnetic circuit has four air gaps, so the total effective air gap in each overall flux path is increased. Also, by embodying that effective gap as four separate gaps instead of a single larger gap, the potential for sideways leakage of flux from the gap is lessened.

FIG. 12 is a schematic cross-section through part of a second multiple-rotor motor. This motor comprises a housing or body 30. Multiple stators 31 are fast with the body of the motor. The stators are symmetrically disposed in a ring around a central axis 32. The stators are regularly spaced around the central axis and at equal distances from it. Multiple rotors 33 are mounted to the body of the motor in such a way that they are each able to rotate about a respective axis 34 with respect to the body. The axes 34 are all parallel with each other and with the central axis 32. The axes 34 are not coincident. In other words, there is a non-zero displacement between the rotor axes 34. The rotors are symmetrically disposed in a ring about the central axis 32 and are located in gaps between the stators. The rotors are linked together mechanically by a linkage that is not shown in FIG. 12, such the rotors are constrained to rotate at the same rate and alternate rotors are constrained to rotate in opposite directions. This can conveniently be done by gears attached to the rotors which intermesh with each other.

Each rotor has a constant cross-section along its respective axis of rotation. Each rotor is shaped so that there are radially projecting regions 35 around each rotor's axis. The radially projecting regions are spaced from each other by radially recessed regions 36. The radial distance from the axis of a respective rotor 34 to the radially outer surfaces of its projecting regions 35 is further than the radial distance from the axis of the respective rotor to the radially outer surfaces of its recessed regions 36. In the embodiment shown in FIG. 12, the radially outer surfaces of the projecting regions 35 of each rotor are at a constant radial distance from the axis of their respective rotor, and the radially outer surfaces of the recessed regions 36 are at a constant, smaller radial distance from the axis of their respective rotor. Thus the radially outer surfaces of the projecting regions lie on a first circular cylinder about the axis of the respective rotor, and the radially outer surfaces of the recessed regions lie on a second, smaller circular cylinder about the axis of the respective rotor.

Each stator is located between two neighbouring rotors. Each stator has a pair of active surfaces 37 which face the neighbouring rotors. The stator is shaped so that the active surface facing each neighbouring rotor is of constant radial distance from the axis of that rotor. Thus the active surfaces are concave in cross section perpendicular to the rotor axes, as shown in FIG. 12.

The space around the rotors and the stators is filled with a non-magnetic fluid material, conveniently a gas such as air. Each rotor is formed of, and may consist of, a magnetically susceptible material, conveniently a ferromagnetic material. Each stator is formed of, and may consist of, a magnetically susceptible material, conveniently a ferromagnetic material. One or more coils are wound around each stator so as to encircle the stator about the transverse axis of the stator, which runs between the active surfaces 37. The points at which the coils intersect the plane of FIG. 12 are shown at 41. Thus the coils are arranged such that when current flows through the coil(s) the stator is magnetically polarised between its active surfaces. Conveniently, a single respective coil can be wrapped around all or part of each stator.

The structure shown in FIG. 12 represents one layer of the motor. In the entire motor, two or more further layers analogous to that shown in FIG. 12 are provided. In each layer the axes of the rotors are coincident with those of the other layers. Rotors with coincident axes in different layers are constrained to rotate together, for example by being mounted on a common shaft of material that is not magnetically susceptible. Conveniently each rotor is mounted on a rotatable shaft which also bears two other rotors in other layers. The projecting and recessed regions of the rotors in each layer are offset circumferentially relative to each other as will be described in more detail below. In an example having three layers, the rotors in each layer may be mechanically offset by 40° relative to the corresponding rotors in the other layers.

In operation the coils are energised in each layer in turn so as to induce the rotors of that layer to rotate on switched-reluctance principles. When the coils in one layer are energised such that the active surfaces 37 on opposite sides of each rotor in that layer are of opposite magnetic polarity, the rotors in that layer are caused to rotate so that the projecting regions are proximal to the stators. Since the rotors in the other layers are linked to those rotors, the rotors in the other layers rotate too, taking their projecting regions out of proximity to their stators. Then the coils in the first layer can be de-energised and the coils in another layer energised to cause continued rotation in the same sense. The process continues until the rotors have moved through a full cycle. The timing of the energising of the coils in different layers can be overlapped to give smoother motion.

To increase the power and/or efficiency of the motor, multiple stators may be energised at the same time provided that the energising of both of those stators will act together to reinforce rotation of the rotors.

To increase the power and/or efficiency of the motor, the projecting regions of the rotors can be magnetically polarised so that they can interact with the stators by means of both attractive and repulsive forces. This can be achieved by means of permanent magnets carried by the rotors, or by means of electromagnetic coils arranged to magnetically polarise the rotors.

In order to energise the coils of the stators and, if provided, the rotors, a control unit 38 can be provided. In one example, the control unit comprises logic circuitry 39 which receives input from a sensor 40 arranged to detect the rotational position of one of the rotors. In dependence on that input the logic circuitry outputs current to the appropriate one(s) of the coils. Alternatively, the control of the coils could be performed by brushes and appropriately configured slip rings rotating with one of the rotors.

The rotors are linked mechanically so that they are constrained to rotate together at the same rate, with adjacent rotors going in opposite directions as illustrated by curved arrows in FIG. 12. This may be achieved by having each rotor bear a gear which meshes with a corresponding gear on the neighbouring rotors. A rotational mechanical output can be taken from one of the rotors or from a gear that meshes with the rotors. In that way the motor can be used to drive a shaft, As indicated above, in an analogous fashion the electrical machine can act as a generator. To achieve this, a mechanical input can be arranged to drive the rotors to rotate and thereby generate electrical current from the electrical machine whilst the coils are switched into and out of circuit appropriately,

In the motor of FIG. 12, when the coils are energised so as to induce the rotors to rotate a magnetic circuit is formed which runs through all the rotors and through all the stators. This is advantageous because it avoids the need for a stator core or back iron around the rotors, which otherwise increases the mass of the motor. However, one or more of the rotors could be replaced by static magnetically susceptible material which is fast with the body of the motor and would complete the magnetic circuit around the ring structure without rotating relative to the body of the motor,

One problem with some conventional motors is the removal of excess heat from the coils. The motor of FIG. 12 and others of those described herein can address this problem by virtue of the fact that the coils are positioned so as to be able to communicate readily with the space surrounding the motor and/or with an interior void in the centre of the motor. This is particularly so since the motor is not enclosed by a stator core or back iron. In this way, heat can be extracted relatively easily from the motor.

When a switched reluctance electrical machine is operating as a motor, in order to generate positive torque, current is applied to the stator coils when the inductance (L) in the magnetic circuit is increasing as the rotor shaft angle (θ) increases i.e.

$$\frac{d L}{d θ} > 0.$$

This approach is based on the standard SRM torque equation:

$$T = \frac{{i}^{2}}{2} \frac{d L}{d θ} .$$

Maximum torque can be achieved during this period of operation. When the machine is operating in generating mode, a negative or (braking) torque can be

$$\frac{d L}{d θ} < 0$$

applied in similar fashion by supplying a stator current when (i.e. wnen me inductance in the magnetic circuit is falling as the rotor shaft angle increases), forcing energy stored in the windings to be fed back to the power supply/store. The amount of energy that can be recovered is a function of the speed of rotation of the rotor(s). By controlling the turn on and turn off timings of the coils and the sense in which they are connected to the power supply/store, the current flow in the machine's stator cores can be controlled such that the SRM is operating either as a motor or as a generator depending whether

$$\frac{d L}{d θ}$$

is rising or falling. This control scheme can be adjusted so as to reduce torque ripples and maximise useful torque generation and regenerative braking.

FIG. 13 illustrates schematically a layer of a third multiple-rotor motor.

The layer shown in FIG. 13 is similar to the layer shown in FIG. 12. In the layer of FIG. 13 the rotors 50 have twelve evenly spaced projections 51 instead of three as in FIG. 12. As in FIG. 12, the stators 52, 53 are located between and proximal to the rotors. However, in contrast to FIG. 12, in FIG. 13 the stators are divided into two sets: one comprising stators 52 located radially inwardly of the circle on which the rotational axes of the rotors lie, and one comprising stators 53 located radially outwardly of that circle. The stators are shaped so that in cross-section they have three limbs, one of which is located proximal to and between two neighbouring rotors, the others of which are located proximal to a single respective one of the rotors. The surfaces of the limbs adjoining the rotors are shaped so that the outer surfaces of the projections of the rotors that are nearest to each limb describe a path of constant distance from that limb as the rotors rotate. One coil can be used to energise each pair of stators 52, 53, the coil encircling those stators about a transverse axis running between the two rotors to which those stators are adjacent. The points at which the coils intersect the plane of FIG. 13 are shown at 54. Each rotational axis of the rotors 50 is parallel to and separated from the other rotational axes of the rotors 50 by a non-zero displacement.

The motor of FIG. 13 operates on similar principles to that of FIG. 12, but has the advantage that all rotors can rotate in the same direction as the narrower teeth do not cause magnetic saturation of the stator elements in a partial overlap condition. Rotors rotating in the same direction can benefit from advantageous gearing arrangements.

FIGS. 14 and 15 illustrate schematically a layer of a fourth multiple-rotor motor, in different configurations at 14 and 15.

The layer of FIG. 14 comprises a body 60 and six rotors 61, 62 arranged to rotate relative to the body about parallel axes. Each rotational axis of the rotors 61, 62 is separated from the other rotational axes of the rotors 61, 62 by a non-zero displacement.

The axes of the rotors lie on and are equally spaced around a circle about a central axis 63. Rotors 61 each have three projecting regions 64 in the form of lobes. Taking the distance between the centres of neighbouring rotors 61 and 62 to be X, the radially outer surface regions of the lobes of each rotor lie on segments of cylinders whose axes are parallel with the axes of the rotors 61, 62 and that are located at X/3 from the centre of the respective rotor 61. The projecting regions are equally spaced circumferentially around the rotor. Rotors 62 are located between rotors 61 on a circle about the central axis 63. Rotors 62 each have six operative surfaces equally spaced circumferentially around the rotor. Each operative surface is convex and is shaped so that, when the centre of the surface is facing the axis of an adjoining rotor 61, as in FIG. 14, its surface lies on a circular cylinder whose axis is parallel with those of the rotors and is located approximately 2×/3 from the axis of the rotor carrying the respective surface, allowing for a small amount of clearance between that surface and a lobe of that rotor 61 when the two meet. The rotors are mechanically linked so that, as in the layers of FIGS. 12 and 13, the rotors are constrained to rotate together with the rotors 61 rotating at twice the rate of the rotors 62, and with alternate rotors rotating in the opposite direction. Thus rotors 61 rotate in one direction at one rate and rotors 62 rotate in the other direction at twice that rate. This can be achieved by, for example, a geared linkage (not shown in FIG. 14).

The rotors 61, 62 are formed of magnetically susceptible material and are separated by a non-magnetic fluid, conveniently air.

FIG. 14 shows the layer in one rotational configuration, and FIG. 15 shows it in another configuration after rotation of rotors 61 by 60° relative to the body of the motor.

Rotors 62 can be magnetically polarised by means of coils, each coil looping around the circle on which the axes of the rotors lie, and at a point between rotors.

Rotors 61 can be magnetically polarised by means of coils, each coil looping around the circle on which the axes of the rotors lie, and at a point between rotors.

Two or more similar layers can be linked together out of the plane of FIG. 14, rotors 61 of each layer being co-axial and linked to rotate together, and similarly for rotors 62 but at half the speed of rotors 61. The rotors of successive layers are offset about their axis with respect to each other: for example, in the case of a three-layer motor, the rotors in each layer can be arranged such that the rotors 61 of each layer are rotated 40° with respect to those of the other layers.

In operation the coils of each of the layers are engaged in turn so as to cause the rotors to rotate continuously using switched reluctance principles. Alternate rotors are energised so that they are polarised north, and the rotors between them are polarised south. This encourages the facing surfaces of neighbouring rotors to move closer to each other.

In the motor of FIG. 14, the magnetic circuit generated by the coils passes through all the rotors in a layer. This represents a particularly efficient design because no additional component is needed to act as a return path for magnetic flux. Therefore, conventional stators and back iron are not required in this preferred embodiment. As all the rotors approach each other the flux runs toroidally around the ring of rotors, permitting relatively high efficiency without the need for a stator.

In the motor as illustrated in FIG. 14, each rotor is cylindrical in shape. The rotors could be thinned in the middle along their length and surrounded there by a coil, the parts of the rotor on either side of the coil being oppositely polarised by the coil. The parts of the rotors that interact could be of constant cross-section but of twisted or helical form, so that they mesh progressively. This could help to reduce torque pulsing, pulsing of the drive current and/or noise during operation.

In the motor as illustrated in FIG. 14, the rotors are of similar radius. The rotors could be of different radii and/or the numbers of lobes or concavities on each rotor could be varied, with the relative rates of rotation of the rotors varied accordingly to allow them to mesh smoothly.

FIGS. 16 and 17 show a further embodiment of a multiple rotor motor.

The motor of FIG. 16 comprises a body 70 and seven rotors 71 configured to rotate relative to the body. The rotation axes of the rotors are parallel and are equally spaced around a circle about a central axis 72. Each rotation axis of the rotors is separated from the rotation axes of the other rotors by a non-zero displacement. Each rotor comprises a central spindle 73 located along the rotation axis of the respective rotor. In the middle of the spindle's length a coil 74 encircles the spindle. At each end of the spindle a set of vanes 75 extends radially from the spindle. Each vane is generally planar, the plane of the vane being oriented perpendicular to the axis of the rotor. The vanes of each spindle extend away from the axis of the spindle and follow generally a common plane which intersects the axis of the rotor. At each end of the spindle half the vanes extend perpendicular to the axis of the rotor in one direction in that plane, and half the vanes extend in the opposite direction. The vanes are spaced along the spindles so that as the rotors rotate the distal regions of vanes of each spindle can pass between the distal regions of vanes of the neighbouring spindle, the distal regions of the vanes of the neighbouring spindles passing close together as they do so. To achieve this, the vanes can conveniently alternate in direction along the length of the spindle, as shown in FIG. 17.

The rotors are formed of magnetically susceptible material and are separated by a non-magnetic fluid, conveniently air.

The rotors are linked together mechanically so that they are constrained to rotate together at the same rate and in the same direction, with the radial planes of the vanes of all the rotors remaining parallel. This may be achieved by a linkage such as a gearing arrangement. For example, gears fast with and coaxial with the rotors can engage a sun wheel.

Each coil is fast with the body of the motor, and encircles a respective spindle of a rotor so that when the coil is energised that rotor is magnetically polarised, the vanes on one side of the coil being polarised opposite to the vanes on the other side. By activating and deactivating the coils in sequence the rotors can be caused to rotate continuously. The control program is such as to, wherever possible, polarise the vanes of two neighbouring rotors oppositely when the motor is at a point in its cycle where those vanes are approaching each other or moving into greater overlap, and to polarise the vanes of neighbouring rotors in the same sense when the motor is at a point in its cycle where those vanes are receding from each other or moving into reduced overlap.

As the vanes of adjacent rotors move relative to each other the motor of FIG. 16 can, with suitable control of the coils, employ multiple driving mechanisms for urging the rotors to rotate. When two sets of vanes are approaching each other but are non-overlapping, the coils of the respective rotors can be energised so as to polarise those vanes oppositely so that they attract and the gap between the vanes decreases. As the vanes begin to overlap and during the stage of increasing overlap, the gap between the vanes remains constant. At this stage the coils can be energised so that the rotors are driven to reduce the reluctance of the magnetic circuit by means of increasing overlap. As, with further rotation, the vanes reach a stage when the overlap between them is decreasing, one of the coils can be reversed so that the rotors are driven to reduce the reluctance of the magnetic circuit by means of reducing overlap. Finally, as with further rotation there is no overlap and the vanes are moving apart the coils can be energised so that the rotors are driven to rotate by means of repulsion between the vanes. Because the motor of FIG. 16 can employ all these drive mechanisms, it can be made to be especially efficient.

It is preferable for the outer edges of all the vanes to be straight, and to make the same angle with the mid-lines of the vanes. In this way, the gap between adjacent vanes is always parallel-sided, increasing the magnetic flux that can be passed for a given current. Most conveniently, the sides of each vane are parallel to the mid-line as shown in FIG. 16.

The motor of FIG. 16 can be constructed using coils that are exclusively circular. This is convenient because circular coils typically cost less and are easier to manufacture than coils of complex shapes, as are often used in other designs of motor. Circular coils can also be more efficient for a given weight because the usage of coil length is optimised.

Since the coils pass around the rotors, the coils can be stationary. Thus this design of motor avoids the need for a stator core or back iron whilst also avoiding the need to communicate electrical current to a mobile rotor.

The vanes of the rotors present a relatively large surface area. This can help to cool the coils and the rotors.

The outermost vanes could be braced to resist them deforming under the influence of magnetic flux during operation.

In the embodiments described above the number of rotors can be varied provided that the number of rotors chosen is appropriate to avoid the motor locking in any configuration.

FIGS. 18 and 19 show a further embodiment of motor. FIG. 18 is an isometric view of part of the motor and FIG. 19 is a plan view of part of the motor,

The motor of FIG. 18 comprises a body 80 defining a central axis 81. Three electromagnets 82 are disposed around the axis 81. The electromagnets are equally spaced around the axis and lie in a common plane perpendicular to the axis. Each electromagnet comprises a U-shaped stator 83 of magnetically susceptible material and a coil 84 whereby the respective stator can be energised. The stators present their ends generally inwards towards the axis 81. Between the ends of the stators is a generally hexagonal armature 85 of a size such that it is free to move between the electromagnets in their plane. As shown in FIG. 19, the armature is mounted on an eccentric crank 86 which is attached to a shaft 87 on which the crank can rotate about the central axis 81. The armature is mounted so that it can rotate relative to the crank but is constrained to inhibit it from rotating more than a few degrees relative to the electromagnets. This may be done by, for example, a series of pins extending axially from the armature which mate with suitably configured grooves on a plate that is fast with the body of the motor, or by a parallelogram linkage to another similar and coordinated motor.

The armature and the stator are formed of magnetically susceptible material, separated by a non-magnetic fluid material, conveniently air.

In operation, the coils are activated in turn to attract the armature to the respective coil. As the crank follows the armature, the shaft 87 is caused to rotate continuously.

Output from the motor can be taken from the shaft 87.

As described above, as the gap between the operative regions of neighbouring interactive components varies, the current required to maintain a particular magnetic field also varies. The current required to maintain a particular magnetic field can be estimated as being linearly dependent on the gap between the operative regions. In a conventional motor, this is not the case. In a conventional motor, the current required to maintain a particular magnetic field is constant over a cycle. The current's linear dependence in the present embodiment is advantageous over the conventional motor as it allows for a smaller average current to be used over a cycle to generate the same magnetic field as in the conventional motor. This allows for a motor that has lower coil losses than many conventional motors.

FIG. 20 illustrates schematically a fifth design of multiple-rotor motor.

The motor of FIG. 20 comprises a set of rotors 300, 301. Each rotor is arranged to rotate about a respective axis 305, 306. The axes of all the rotors are parallel and lie on a circle about the motor's centre point. Each rotor axis is separated from the other rotor axes by a non-zero displacement. Around that circle the rotors alternate between those 300 of a first type and those 301 of a second type.

The rotors of the first type have a central shaft 303 which runs through a coil 302. On either side of the coil and fast with the shaft 303 is a structure having three projections or lobes extending radially outward from the shaft and terminating in radially outward-facing surfaces which lie on a circular cylinder about an axis that is one-third of the shortest inter-rotor distance from the axis of the of the rotor. The structures on either side of the coil are identical and rotationally aligned.

The rotors of the second type have a central shaft 304 which runs through a coil 302. On either side of the coil is a structure having six concave surfaces which are configured to mesh with the rotors of the first type without contact being made. Thus when an interacting surface of the rotor of the second type is facing an interacting surface of a neighbouring rotor of the first type, each concave surface falls on a circular cylinder that is two-thirds of the shortest inter-rotor distance from the axis of the of the rotor and of slightly greater radius than that on which the outward-facing surfaces of the neighbouring rotor lie. The structures on either side of the coil are identical and rotationally aligned.

The radially outward-facing surfaces and the concave surfaces are regularly spaced around their respective rotors. The rotors are coupled by gearing so that neighbouring rotors are constrained to rotate together in opposite directions, with the rotors 300 rotating at twice the rate of the rotors 301.

The rotors are formed of ferromagnetic material. When a coil is energised it causes the two structures of the rotor whose shaft it surrounds to be magnetically polarised relative to each other. In operation, the coils are energised so that, where possible, adjacent rotors whose closest surfaces are moving towards each other in the operating direction of the motor are polarised oppositely, so as to attract each other; and adjacent rotors whose closest surfaces are moving away from each other in the operating direction of the motor are polarised similarly, so as to repel each other.

It has been found that in order for the rotors to mesh effectively, certain numbers of rotors are needed, depending on the number of interacting concave and convex surfaces on the rotors. For example, in the case of a 3-lobed rotor carrying the convex surfaces and a 6-sided rotor carrying the concave surfaces, machines having 6, 10 and 14 rotors (among other numbers) can be used. Rotors having other numbers of surfaces than 3 and 6 can be used.

In the design of FIG. 20, neighbouring rotors of the ring approach each other successively. Therefore, as a result, no additional layers are needed in order for continuous rotation to be had.

FIG. 21 illustrates schematically a sixth design of multiple-rotor motor.

The motor of FIG. 21 is similar to that of FIGS. 4 to 11. It comprises rotors 400, outer stator elements 401 and inner stator elements 402. The rotors are each mounted so that they can rotate relative to the body of the motor. The rotation axes of the rotors are parallel and are evenly spaced around a circle perpendicular to the axes about the centre of the motor. Therefore, each rotation axis of a rotor is displaced from rotation axes of other rotors by a non-zero displacement. The rotors are coupled together by a mechanical linkage such that they are constrained to rotate together in the same direction and at the same rate. This can be achieved by means of a sun wheel rotating about the centre axis of the motor and which meshes with planet wheels rotationally fast with each rotor. The rotors and stator elements are formed of ferromagnetic material, and the rotors can be energised by means of coils in the same way as in the motor of FIGS. 4 to 11.

The motor of FIG. 21 differs from that of FIGS. 4 to 11 in that it has eight rotors. Each rotor is offset rotationally by 9° relative to its neighbours, and the stator elements are arranged so that during the motor's cycle the rotors can achieve the state shown in FIG. 21 in which all the rotors are positioned so that alternate pairs of inner and outer stator elements are confronted by radially-projecting salients of both the rotors that neighbour those stator elements. Since the salient are equally spaced around the motor, the effect of this is that when each rotor when exactly aligned to one neighbouring rotor it is exactly misaligned to the other neighbour. Thus there is a 180° phase shift across each rotor. Hence, alternate pairs of rotors are attracting each other, and the remaining pairs of neighbouring rotors are repelling each other. This is efficient because, except at the instant when the flux across all the air gaps between stator elements and a rotor are exactly balanced, the stator is being actively attracted or repelled.

The commutation scheme for this motor is as follows, using the same notation as used in the tables above.

| 1 | 2 | 3 | 4 | 5 | 6 | 7 | 8 |
|---|---|---|---|---|---|---|---|
| 2 | 3 | 4 | 5 | 6 | 7 | 8 | 1 |
| −1 | 1 | −1 | 1 | −1 | 1 | −1 | 1 |
| 1 | −1 | 1 | −1 | 1 | −1 | 1 | −1 |
| 1 | 2 | 3 | 4 | 5 | 6 | 7 | 8 |
| N | N | S | S | N | N | S | S |
| N | S | S | N | N | S | S | N |

It will be seen that one phase of the rotor (that employed for rotors 1, 3, 5 and 7 in the table above) is DC, whereas the other phase of the rotor (that employed for rotors 2, 4, 6 and 8 in the table above) is square-wave AC. The four coils of each phase can be connected together electrically and energised together to allow them to be conveniently driven by a common outlet of a control unit. The torque of the motor can be regulated by regulating the current of the DC phase and the AC phase to the same magnitude. The torque generated is approximately proportional to current squared.

Since there is an instant between the two phases when the forces are balanced, the motor cannot generate torque at that point. That is not an issue once the motor is in motion since the inertia of the motor will carry it past that point. To prevent the motor being stuck at that point when it is stationary, various measures can be taken. Two electrical machines of the type shown in FIG. 2 can be connected together mechanically, with the rotors of the machines offset relative to each other by 90°. The two machines could share a sun wheel, with the pinions attached to the rotors of one machine engaging with the sun wheel in the gaps between the points at which the pinions of the other machine engage the sun wheel.

FIG. 22 shows two further designs of motor. The motors are illustrated one inside the other, to allow a comparison to be made of their size, but they are mechanically independent of each other.

The first motor is a relatively conventional permanent magnet motor. It comprises a stator ring 500 of ferromagnetic material. Extending radially inwardly from the stator ring are projections 501, also of ferromagnetic material. Coils are wrapped around every second projection, some of which are illustrated at 502. Each coil can be selectively activated to polarise the projection around which it is wrapped with a desired magnetic polarisation. Within the projections is a ring of permanent magnets 503. The permanent magnets are coupled together mechanically so that they can rotate together within the stator ring about an axis extending out of the plane of FIG. 22. Adjacent ends of adjacent permanent magnets have opposite magnetic polarity. In operation, the coils can be energised in turn to attract and/or repel nearby ones of the permanent magnets, causing the ring of permanent magnets to rotate relative to the stator. A mechanical output can be taken from the ring of permanent magnets.

The second motor of FIG. 22 has four rotors 520, which are mounted so as to be rotatable about respective parallel axes extending out of the plane of FIG. 22. The respective parallel axes are displaced from each other by a non-zero displacement. Four permanent magnets 521 are arranged circumferentially around each rotor, forming a ring around the body of the rotor with each permanent magnet spaced circumferentially from its neighbours by a gap 522 of air or another non-magnetic material. The permanent magnets are arranged so that adjacent ends of adjacent permanent magnets have opposite magnetic polarity. Three stator limbs of ferromagnetic material extend between neighbouring rotors. The stator limbs are fast with the body of the motor. The stator limbs comprise inner limbs 523, middle limbs 524 and outer limbs 525, Each limb is located so that each of its ends lies close to the path described by the outer surfaces of the permanent magnets on the rotor that end is closest to, but spaced from that path by a gap of non-magnetic material, most conveniently an air gap. The limbs are separated from each other by non-magnetic material. Each inner limb extends between two regions of the rotors that it neighbours, which regions are relatively inward with respect to the centre point of the motor. Each outer limb extends between two regions of the rotors that it neighbours, which regions are relatively outward with respect to the centre point of the motor. Each middle limb extends between two regions of the rotors that it neighbours, which regions are between those at which the inner and outer limbs adjoin the rotors. Coils 526, only some of which are illustrated, loop around each of the middle stator limbs. Coils 527, only some of which are illustrated, loop around the ends of the inner and outer stator limbs and the rotors. The coils can be selectively energised.

In operation of the second motor of FIG. 22, the coils are energised appropriately to urge the rotors to rotate through magnetic interaction between the permanent magnets borne by the rotors and the stator limbs. A mechanical output can be taken from the rotors.

The first and second motors of FIG. 22 have the same number of permanent magnets. However, it will be seen that because the second motor employs multiple rotors, it is considerably more compact than the first motor of FIG. 22. Where a motor of the type described herein is controlled by control logic, the position of the rotors can be determined by dedicated position sensors or in another way, for example by estimating the response to excitation of the electrical circuit including one or more coils. This latter mechanism can avoid the need for a dedicated position sensor.

Among other applications, the electrical machines described herein can be suitable for use for driving hybrid electrical vehicles or fully electrical vehicles, and for generating electricity from regenerative braking in such vehicles. The electrical machines can conveniently be implemented as wheel motors, in which each motor is coupled to a drive wheel of the vehicle that is coaxial with the output shaft of the motor, or in other configurations.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1-134. (canceled)

135. An electrical machine comprising:
a rotor arranged to revolve about an axis; and
a static electromagnetic coil, the electromagnetic coil encircling the axis of the rotor for magnetically polarising the rotor.

136. An electrical machine as claimed in claim 135, wherein the electrical machine further comprises:
one or more further rotors, each rotor being arranged to revolve about its own respective axis; and
one or more further electromagnetic coils, each electromagnetic coil being associated with a rotor and encircling the axis of that rotor so as to magnetically polarise that rotor.

137. An electrical machine as claimed in claim 136, wherein each of the rotors neighbours at least one other rotor and wherein each rotor is arranged to magnetically interact with the or each neighbouring rotor.

138. An electrical machine as claimed in claim 137, wherein the machine is arranged so that during operation the electromagnetic coils of at least two neighbouring rotors magnetically polarise their respective rotors in a way that causes a repulsion between the neighbouring rotors.

139. An electrical machine as claimed in claim 137, wherein the machine is arranged so that during operation the electromagnetic coils of at least two neighbouring rotors magnetically polarise their respective rotors in a way that causes an attraction between the neighbouring rotors.

140. An electrical machine as claimed in claim 136, wherein the machine is arranged so as to reverse the polarity of the magnetic field induced in a rotor when a portion of that respective rotor is proximal to a portion of an adjacent rotor.

141. An electrical machine as claimed in claim 135, wherein one electromagnetic coil is arranged to encircle the axes of multiple rotors and is configured to magnetically polarise those multiple rotors.

142. An electrical machine as claimed in claim 135, wherein each electromagnetic coil is associated with a single respective rotor and is arranged to encircle the axis of and magnetically polarise only that single respective rotor.

143. An electrical machine as claimed in claim 135, wherein each rotor has a respective coil wound around it and separated from the body of the rotor by a lining of non-magnetically-susceptible material.

144. An electrical machine as claimed in claim 143, wherein the internal diameter of the coil is smaller than the largest external diameter of the rotor.

145. An electrical machine as claimed in claim 135, wherein at least one of the rotors is composed of a ferromagnetic material and the machine is arranged to magnetically energise and magnetically deenergise the ferromagnetic material during operation of the machine.

146. An electrical machine as claimed in claim 135, wherein the respective axes of the rotors are parallel to each other.

147. An electrical machine as claimed in claim 135, wherein the respective axes of the rotors are separated from each other by a non-zero displacement.

148. An electrical machine as claimed in claim 135, wherein the electrical machine is a switched reluctance motor or generator.

149. An electrical machine as claimed in claim 135, wherein the electrical machine further comprises a component that is arranged to magnetically interact with a polarised one of the rotors.

150. An electrical machine as claimed in claim 149, wherein the said component is a stator that comprises at least two radial projections and wherein the rotor is arranged to magnetically interact with the said component through a magnetic field induced in the component in one of the projections.

151. An electrical machine as claimed in claim 150, wherein the rotor is arranged to magnetically interact with said component through magnetic fields induced in the said component in both of the projections.

152. An electrical machine as claimed in claim 151, the machine being configured such that during operation the magnetic field induced in one of the projections is of opposite polarity to the magnetic field induced in the other of the projections.

153. An electrical machine as claimed in claim 149, wherein the said component is a rotor that comprises at least two radial projections and wherein the rotor is arranged to magnetically interact with the said component through a magnetic field induced in the component in one of the projections.

154. An electrical machine as claimed in claim 150, wherein the rotor bears further radial projections and the rotor and the said other component are configured such that the projections of the rotor and the projections of the said other component overlap in the axial direction of the rotor during rotation of the rotor.

155. An electrical machine as claimed in claim 154, wherein the projections are configured so as to cause the gap between the projections of the rotor and the projections of the said other component to remain substantially constant whilst the projections are overlapping.

156. An electrical machine as claimed in claim 154, wherein the projections are configured so as to cause the gap between the projections of the rotor and the projections of the said other component to be substantially uniform over the length of the projections whilst the projections are not overlapping.

157. An electrical machine as claimed in claim 135, wherein the rotors each comprise at least one protrusion and wherein the rotors are configured such that when a protrusion of one rotor is proximal to a protruding portion of another rotor, those protrusions overlap in a direction parallel to the rotation axis of the rotor.

158. An electrical machine as claimed in claim 135, further comprising a sun gear for extracting a rotational drive from the machine and wherein each rotor comprises a planetary gear arranged to mesh with the sun gear.

159. An electrical machine as claimed in claim 135, wherein the rotors are arranged to have an angular offset relative to each other such that the electrical machine can cause the rotors to revolve from any configuration by selectively polarising the rotors.

160. An electrical machine as claimed in claim 135, wherein the rotors are mechanically linked to each other such that they each revolve in the same direction during operation.

161. An electrical machine as claimed in claim 135, wherein all of the rotors are composed of a ferromagnetic material and the machine is arranged to magnetically energise and magnetically deenergise the ferromagnetic material during operation of the machine.

162. An electrical machine from which energy can be extracted, the electrical machine comprising
at least two rotors, each rotor being arranged to revolve about a respective axis and further being arranged to magnetically interact with at least one other of the rotors in order to permit energy to be extracted from the machine;
the rotors each comprise at least one protrusion and the rotors are configured such that when a protrusion of one rotor is proximal to a protruding portion of another rotor, those protrusions overlap in a direction parallel to the rotation axis of the rotor.

163. An electrical machine as claimed in claim 162, wherein the at least one protrusion is a vane.

164. An electrical machine as claimed in claim 163, wherein each vane is generally planar, the plane of the vane being orientated perpendicular to the respective axis of the rotor.

165. An electrical machine as claimed in claim 162, wherein each rotor comprises a central spindle located along the rotation axis of the respective rotor, at each end of the spindle a set of vanes extends radially from the spindle.

166. An electrical machine as claimed in claim 165, wherein the vanes of each spindle extend away from the respective axis of the rotor and follow generally a common plane which intersects the respective axis of the rotor

167. An electrical machine as claimed in claim 166, wherein at each end of the spindle half the vanes extend perpendicular to the respective axis of the rotor in one direction in the common plane and half the vanes extend in the opposite direction.

168. An electrical machine as claimed in claim 165, wherein the vanes alternate in direction along the length of the spindle.

169. An electrical machine as claimed in claim 165, wherein the rotors are linked together mechanically so that they are constrained to rotate together at the same rate and in the same direction, with the radial planes of the vanes of all the rotors remaining parallel.

170. An electrical machine as claimed in claim 162, wherein the respective axes of the rotors are separated from each other by a non-zero displacement.

171. An electrical machine as claimed in claim 162, wherein the respective axes of the rotors are parallel to each other.

172. An electrical machine as claimed in claim 162, comprising a coil corresponding to each rotor encircling the respective axis of the rotor and wherein each rotor is arranged to be magnetically polarised by the corresponding coil to rotate relative to the coil and wherein the coil is fixed relative to the body of the motor.

173. An electrical machine as claimed in claim 172, wherein each coil is arranged to be energised independently of the other coils.

174. An electrical machine as claimed in claim 162, wherein the electrical machine comprises at least three rotors, each rotor being arranged to revolve about a respective axis and further being arranged to magnetically interact with at least two other rotors in order to permit energy to be extracted from the machine.

175. An electrical machine as claimed in claim 162, wherein the electrical machine comprises at least four rotors, each rotor being arranged to revolve about a respective axis and further being arranged to magnetically interact with at least three other rotors in order to permit energy to be extracted from the machine.

176. An electrical machine as claimed in claim 162, wherein the magnetic interaction between the rotors creates a path of least reluctance that passes through at least two rotors in the machine.

177. An electrical machine as claimed in claim 162, wherein the magnetic interaction between the rotors forms a magnetic circuit, the magnetic material of that circuit comprising material of the rotors and material of a static element.

178. An electrical machine as claimed in claim 177, wherein the static element is an element of ferromagnetic material having a magnetically energised state and a magnetically unenergised state during operation of the machine.

179. An electrical machine as claimed in claim 177, wherein the static element is an electromagnet.

180. An electrical machine as claimed in claim 162, wherein the at least two rotors are arranged to interact with each other directly and not through an intermediary component.

181. An electrical machine as claimed in claim 162, wherein the magnetic interaction between the rotors forms a magnetic circuit, the magnetic material of that circuit being substantially wholly material of the rotors.

182. An electrical machine as claimed in claim 162, wherein at least one of the rotors is composed of a ferromagnetic material and the machine is arranged to magnetically energise and magnetically deenergise the ferromagnetic material during operation of the machine.

183. An electrical machine as claimed in claim 162, wherein the electrical machine is a switched reluctance motor or switched reluctance generator.

184. An electrical machine as claimed in claim 162, wherein the rotors are arranged to have an angular offset relative to each other such that the electrical machine can cause the rotors to revolve from any configuration by selectively polarising the rotors.

185. An electrical machine as claimed in claim 162, wherein the rotors are mechanically linked to each other such that they each revolve in the same direction during operation.

186. An electrical machine as claimed in claim 162, wherein all of the rotors are composed of a ferromagnetic material and the machine the arranged to magnetically energise and magnetically deenergise the ferromagnetic material during operation of the machine.

187. An electrical machine from which energy can be extracted, the electrical machine comprising:
at least three rotors, each rotor being arranged to revolve about a respective axis and further being arranged to magnetically interact with at least two other rotors in order to permit energy to be extracted from the machine;
wherein neighbouring rotors interact with each other through at least one intermediary stator component positioned between neighbouring rotors, the stator components being arranged to be magnetically polarised by static electromagnetic coils; and
wherein the electrical machine is a switched reluctance motor or generator.

188. An electrical machine according to claim 187, wherein the magnetic interaction between the rotors and stators forms a magnetic circuit, the magnetic material of that circuit comprising material of the rotors and material of the stators; and
wherein, when the electrical machine is operating as a motor the electrical machine is configured so that current is applied to the stator coils when the inductance in the magnetic circuit is increasing as the rotor shaft angle increases, or
when the electrical machine is operating as a generator the electrical machine is configured so that current is applied to the stator coils when the inductance in the magnetic circuit is falling as the rotor shaft angle increases.

189. An electrical machine according to claim 187, wherein each stator has a pair of active surfaces which face neighbouring rotors, and the coils are arranged such that when current flows through the coils the stator is magnetically polarised between its active surfaces.
